(19) United States
(12) Patent Application Publication
(10) Pub. No.: US 2003/0076597 A1
(43) Pub. Date: Apr. 24, 2003

(54) Kaleidoscope

(76) Inventor: Chia Hui Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/270,300

(22) Filed: Oct. 15, 2002

(30) Foreign Application Priority Data
Oct. 19, 2001 (TW) 090217879

(51) Int. Cl. G02B 27/08

(52) U.S. Cl. 359/617

(57) ABSTRACT

A kaleidoscope includes a stationary portion and a movable portion. The stationary portion includes a tubular body inside which a prism is arranged. The tubular body has opposite ends to which an eyepiece and a lens device are respectively attached. The movable portion includes a support rod having a first section rotatably mounted to the stationary portion and a second section to which a transparent container is rotatably attached. The container defines an interior space divided into a number of isolated compartments by partition plates fixed inside the container for receiving and containing small objects of different sizes, shapes and colors and liquids. The support rod is arranged to position the container, at least partly, in front of the lens device and allowing the container to rotate whereby compartments of the container can selectively and sequentially pass in front of the lens device, which directs image of the objects inside the compartments into the prism for forming versatile patterns

### BACKGROUND OF THE INVENTION

1. Field of the Invention

The present invention generally relates to a kaleidoscope, and in particular to a kaleidoscope comprising a number of different sets of colorful particles or flakes to enhance versatility of patterns of the kaleidoscope.

2. Background of the Invention

Kaleidoscopes have long been a popular toy for children and even adults. The conventional kaleidoscope comprises an elongate tubular body inside which a prism consisting of three mirrors is fixed. Colorful particles and flakes are loosely filled in the prism whereby by shaking the kaleidoscope, the flakes and particles change their positions inside the kaleidoscope and a variety of different colorful patterns can be formed by means of reflection of the images of the particles and flakes inside the kaleidoscope.

The conventional kaleidoscope suffer a disadvantage in that the particles and flakes, once put into the kaleidoscope, cannot be changed easily. This limits the versatility of the kaleidoscope.

It is thus desirable to provide an improved kaleidoscope structure for overcoming the above-mentioned problems.

### SUMMARY OF THE INVENTION

Accordingly, an object of the present invention is to provide a kaleidoscope, which comprises a number of different sets of colorful pattern generating particles/flakes.

Another object of the present invention is to provide a kaleidoscope wherein the different sets of colorful pattern generating particles/flakes can be readily switched with one another for enhancing the versatility of the pattern displayed.

Another object of the present invention is to provide a kaleidoscope comprising a stationary portion and a movable portion, the movable portion comprising sets of different colorful pattern generating particles/flakes which can be switched with each other with the movable portion moving with respect to the stationary portion.

To achieve the above objects, in accordance with the present invention, there is provided a kaleidoscope comprising a stationary portion and a movable portion. The stationary portion comprises a tubular body inside which a prism is arranged. The tubular body has opposite ends to which an eyepiece and a lens device are respectively attached. The movable portion includes a support rod having a first section rotatably mounted to the stationary portion and a second section to which a transparent container is rotatably attached. The container defines an interior space divided into a number of isolated compartments by partition plates fixed inside the container for receiving and containing small objects of different sizes, shapes and colors and liquids. The support rod is arranged to position the container, at least partly, in front of the lens device and allowing the container to rotate whereby compartments of the container can selectively and sequentially pass in front of the lens device, which directs image of the objects inside the compartments into the prism for forming versatile patterns.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a kaleidoscope constructed in accordance with a first embodiment of the present invention;

FIG. 2 is an exploded view of the kaleidoscope of FIG. 1;

FIG. 3 is a side elevational view of the kaleidoscope of FIG. 1, a portion of the kaleidoscope being broken to show inside details;

FIG. 4 is a perspective view showing a different way of use of the kaleidoscope of FIG. 1;

FIG. 5 is an exploded view of a kaleidoscope constructed in accordance with a second embodiment of the present invention;

FIG. 6 is an exploded view of a kaleidoscope constructed in accordance with a third embodiment of the present invention;

FIG. 7 is a side elevational view of a kaleidoscope constructed in accordance with a fourth embodiment of the present invention, a portion of the kaleidoscope being broken to show inside details; and

FIG. 8 is an exploded view of a kaleidoscope constructed in accordance with a fifth embodiment of the present invention.

### DETAILED DESCRIPTION OF THE PREFERRED EMBODIMENTS

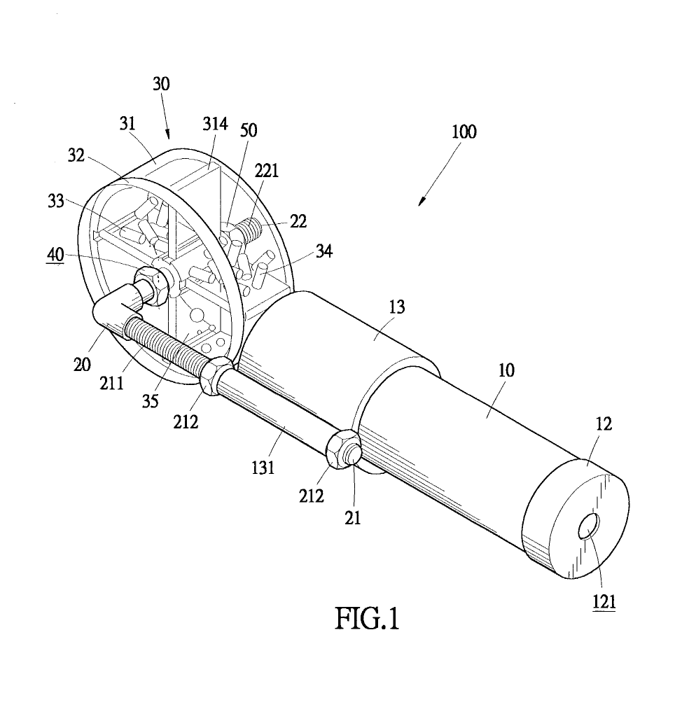

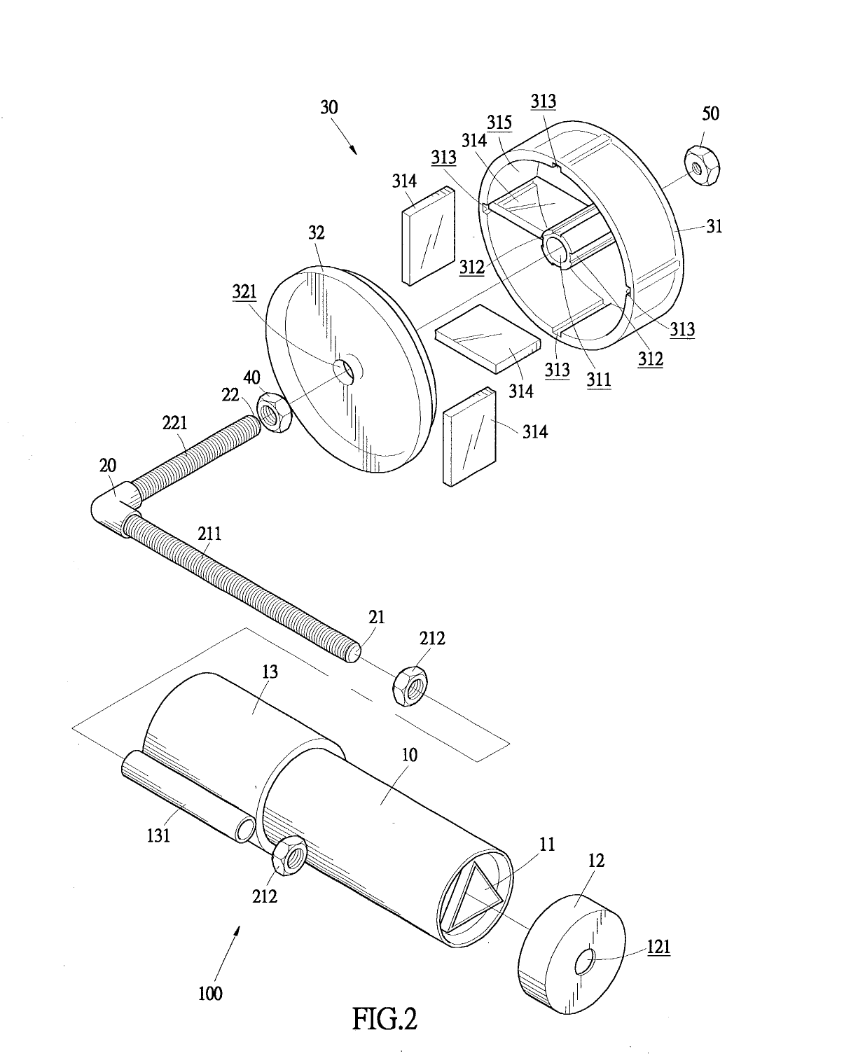

With reference to the drawings and in particular to FIGS. 1 and 2, a kaleidoscope constructed in accordance with a first embodiment of the present invention, generally designated with reference numeral 100, comprises a stationary portion (or sub-assembly) and a movable portion (or sub-assembly) movably attached to the stationary portion. The stationary portion comprises an elongate tubular body 10 within which a prism 11 is fixed. The tubular body 10 has opposite ends to which a cap 12 and a lens device 13 are attached respectively. The cap 12 defines a central bore 12, serving as an observing window or an eyepiece. The lens device 13 comprises optical element(s), preferably encased in a housing, for directing images of the kaleidoscope 100 into the prism 11 within the tubular body 10. A tubular retainer 131 is formed on an outside surface of the lens device 13.

The movable portion of the kaleidoscope 100 comprises a support rod 20 having first and second sections 21, 22 each having external threading 211, 221 formed thereon. In the embodiment illustrated in FIGS. 1 and 2, the first and second sections 21, 22 are arranged so as to form an included angle therebetween which is 90 degrees in this case whereby the first and second sections 21, 22 of the support rod 20 are substantially perpendicular to each other and thus form an L-shape. It is, however, understood that the included angle between the first and second sections 21, 22 can be other than 90 degrees. The tubular retainer 131 has an inside diameter sufficient to allow for extension of either first or second section 21, 22 therethrough. In the embodiment illustrated in FIG. 1, the first section 21 of the support rod 20 is received in the tubular retainer 131 with the second section 22 transverse extending across the lens device 13. Two nuts 212 threadingly engage the threading 211 of the first section 21 of the support rod 20 on opposite sides of the tubular retainer 131 so as to fix the support rod 20 in the tubular retainer 131 against axial movement of the first section 21 of the support rod 20. However, rotation of the support rod 20 with respect to the tubular retainer 131 is still allowed.

A container 30 made of a transparent or light-transmitting material comprises a casing 31 having an opening (not labeled) closed by a cover 32 whereby an interior space is defined in the container 30. A central hub 311 defining a bore (not labeled) is formed in the casing 31 and extending between the cover 32 and a bottom (not labeled) of the casing 31. In the embodiment illustrated, the casing of the container 30 is a cylindrical body having a closed bottom and an opposite open end closed by the cover 32. The central hub 311 extends from the bottom toward the cover 32. The cover 32 defines a through hole 321 in alignment with the bore of the central hub 311 for the extension of the second section 22 of the support rod 20 therethrough whereby the container 30 is rotatable about the second section 22. A number of paired slits 312, 313 are formed in both the hub 311 and a side wall (not labeled) of the casing 31 for receiving edges of partition plates 314 thereby fixing the partition plates 314 inside the container 30. The partition plates 314 divide the interior space of the container 30 into a number of isolated chambers 315 for accommodating particles 33 and flakes 34 of different sizes, shapes and colors and/or liquids 35 of different colors. The particles 33 and flakes 34 and even the liquids 35 can be of different colors. The size of the chambers 315 can also be arbitrarily selected as desired.

The first section 21 of the support rod 20 is received in the tubular retainer 131 so as to allow the second section 22 to extend in a direction substantially transverse the lens 131. Two nuts 40, 50 threadingly engage the threading 221 of the second section 22 of the support rod 20 on opposite sides of the container 30 for selectively positioning the container 30 with respect to the lens device 13.

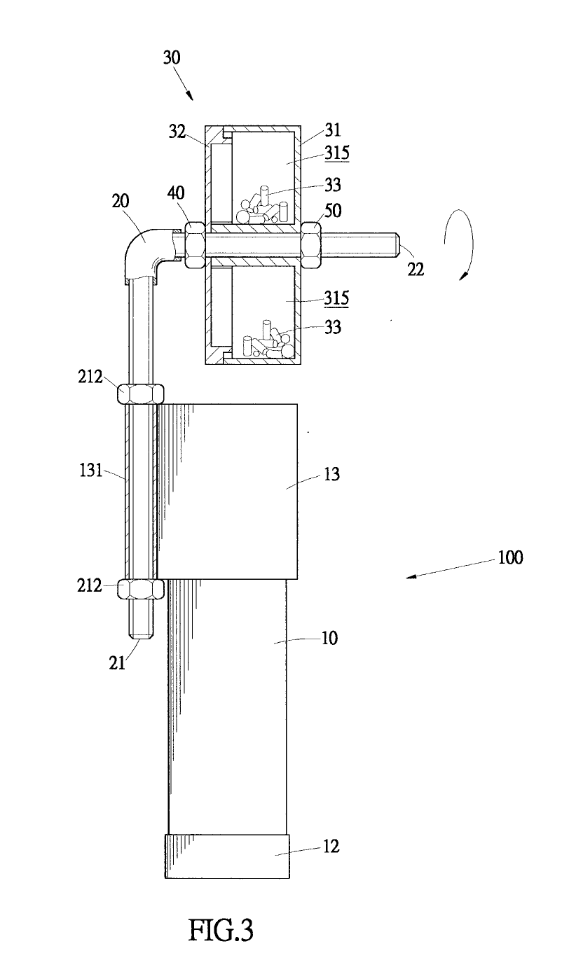

Also referring to FIG. 3, which shows one way of operating the kaleidoscope 100, a user (not shown) may use one hand holding the tubular body 10 and another hand rotating the container 30 as indicated by arrow of FIG. 3 to move the compartments 315 sequentially across the lens 13 whereby the user can observe the versatile and colorful changes made in the prism 11 through the observing window 121. The rotation of the container 30 can be done either clockwise or counterclockwise. Further, the lens device 13 can be mounted to the end of the tubular 10 so as to be rotatable about an axis of the tubular body 10. This allows more versatile combination and change of the colorful patterns displayed in the prism 11.

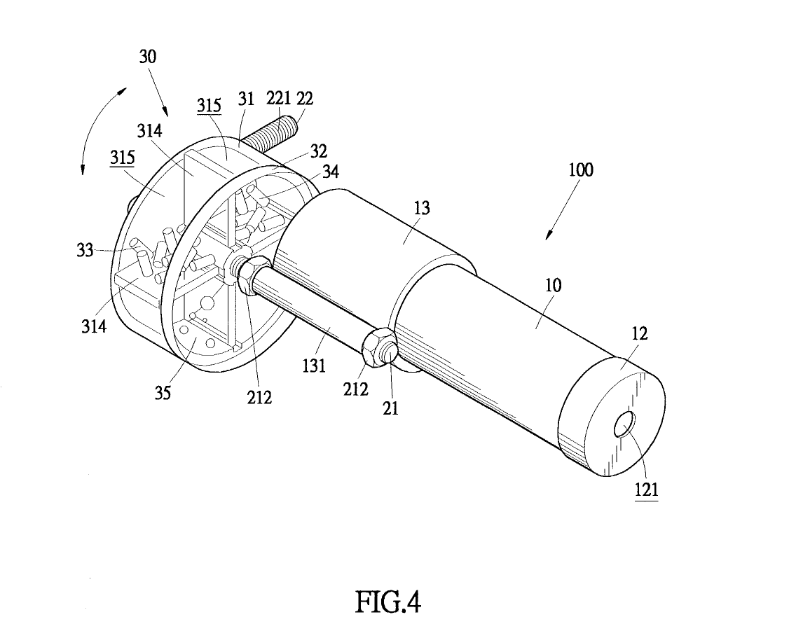

FIG. 4 shows another way of operating the kaleidoscope 100 shown in FIGS. 1 and 2. The container 30 is fit over the first section 21 of the support rod 20 and located between the lens 13 and the second section 22 with the cover 32 (or alternatively, the bottom of the casing 31 opposite to the cover 32) facing the lens device 13. By rotating the container 30 about the first section 21 (as indicated by the arrow of FIG. 4), the compartments 315 of the container 30 are sequentially moved across the lens device 13.

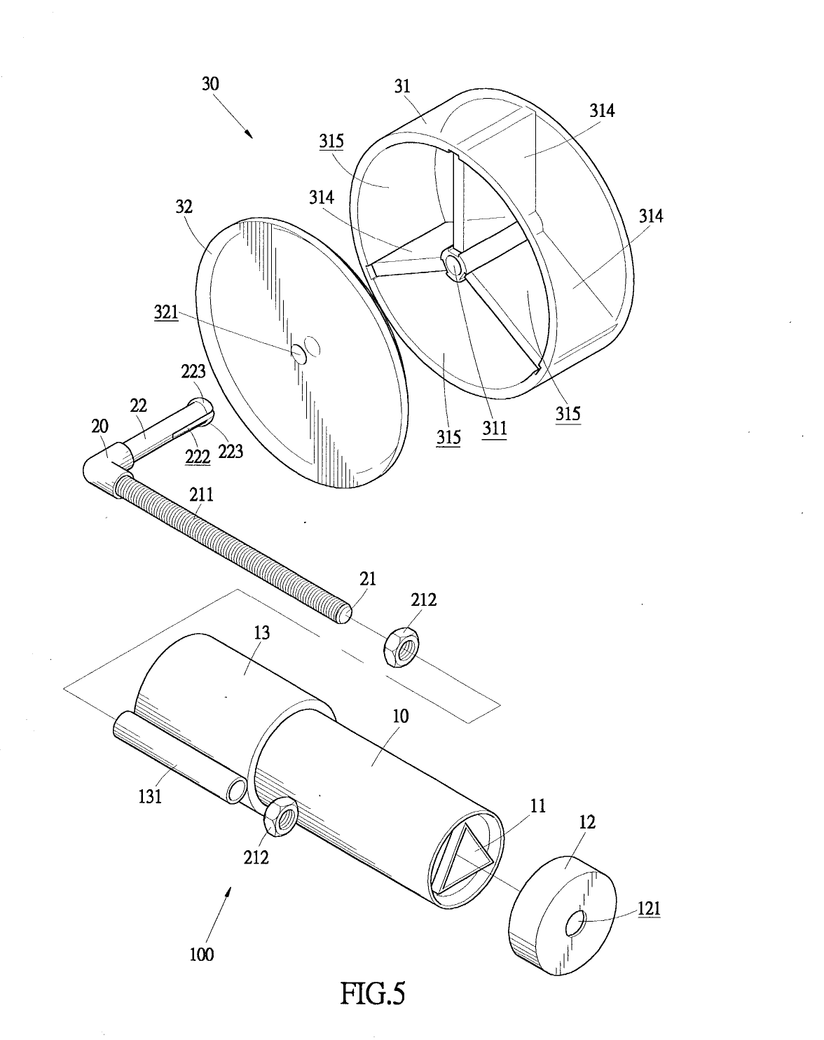

FIG. 5 shows a second embodiment of the kaleidoscope 100 in accordance with the present invention. In the second embodiment, the second section 22 of the support rod 20 is not threaded. In stead, a slit 222 is defined in a remote end of the second section 22, preferably cutting through the remote end of the second section 22 in a diametrical direction, dividing the remote end of the second section 22 into two opposing portions that are deformable toward each other for reducing overall cross-sectional size thereof. A ring-like expanded portion 223 is formed on and around the remote end of the second section 22 whereby by deforming the two portions of the remote end of the second section 22, the expanded portion 223 is allowed to pass through the bore of the central hub 311 of the container 30 for attaching the container 30 to the second section 22 of the support rod 20.

It is obvious to those having ordinary skills to form more slits in the remote end of the second section 22 of the support rod 20 to provide capability of reduction of overall cross-sectional area.

The remaining parts of the kaleidoscope 100 of the second embodiment are identical to their counterpart of the first embodiment except the number of the compartments 315 which is simply a choice of design. Thus no further description is needed herein.

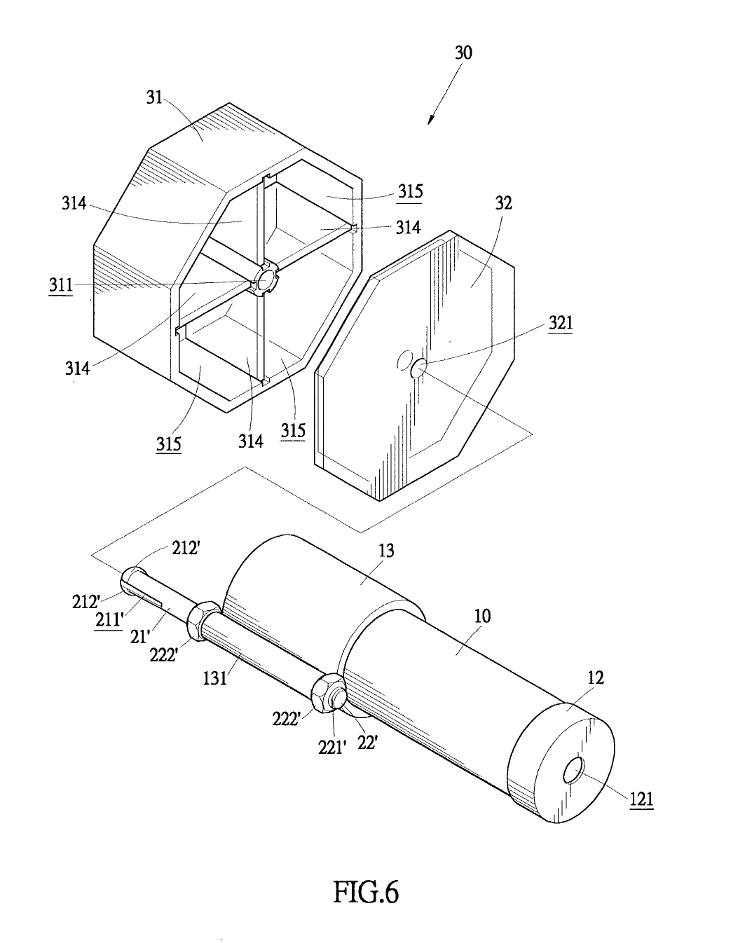

FIG. 6 shows a third embodiment of the kaleidoscope 100 in accordance with the present invention. The first and second sections 21′, 22′ of the support rod 20′ are axially aligned with each other whereby the support rod 20′ is simply a straight member, rather than L-shaped. One of the sections 21′, 22′ of the support rod 20′ is externally threaded while the other is not. In the embodiment illustrated, the second section 22′ of the support rod 20′ is externally threaded, as indicated by reference numeral 221′. The second section 22′ of the support rod 20′ is received in the tubular retainer 131 and kept in position by two nuts 222′ engaging the threading 221′ on opposite sides of the tubular retainer 131. The remote end of the first section 21′ of the support rod 20′ is formed with a slit 211′ allowing opposing portions of the remote end to be deformable with respect to each other. Apparent enough, there can be more than one such slit 211′. A ring-like expanded portion 212′ is formed on and around the remote end of the first section 21′ which is allowed to pass the bore of the central hub 311 by deforming the remote end of the first section 21′ for attaching the container 30 to the support rod 20′. The cover 32 of the container 30 is now facing the lens device 13 and the change of the colorful flakes or particles can be clearly shown in the prism 11 of the tube 10.

Besides the above described modifications, the remaining parts of the kaleidoscope 100 of the third embodiment are identical to their counterpart of the first embodiment except the container 30 of the third embodiment being octagonal, rather than cylindrical. Such a change is simply a choice of design. Thus no further description is needed herein.

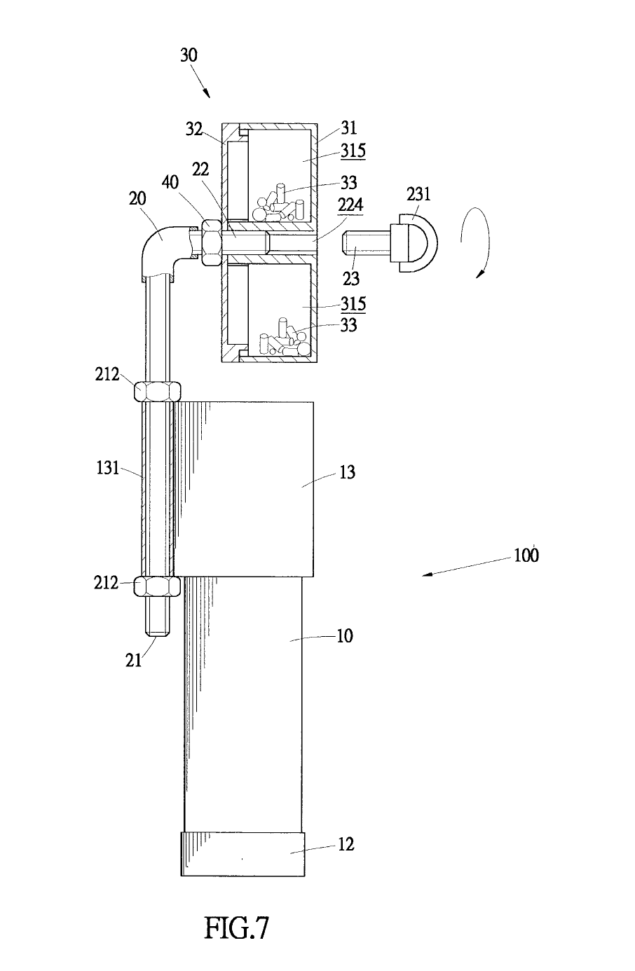

FIG. 7 shows a fourth embodiment of the kaleidoscope in accordance with the present invention. In the fourth embodiment, a remote end of the second section 22 of the support rod 20 is formed with an inner-threaded hole 224 for threading engagement with a bolt 23. The bolt 23 has an expanded portion for retaining the container 30 on the second section 22 of the support rod 20. Further, a movable tab 231 is attached to the bolt 23 which can be selectively moved to abut against the container 30 and thus more securely retain the container 30.

Besides the above described modifications, the remaining parts of the kaleidoscope 100 of the fourth embodiment are identical to their counterpart of the first embodiment and thus no further description is needed herein.

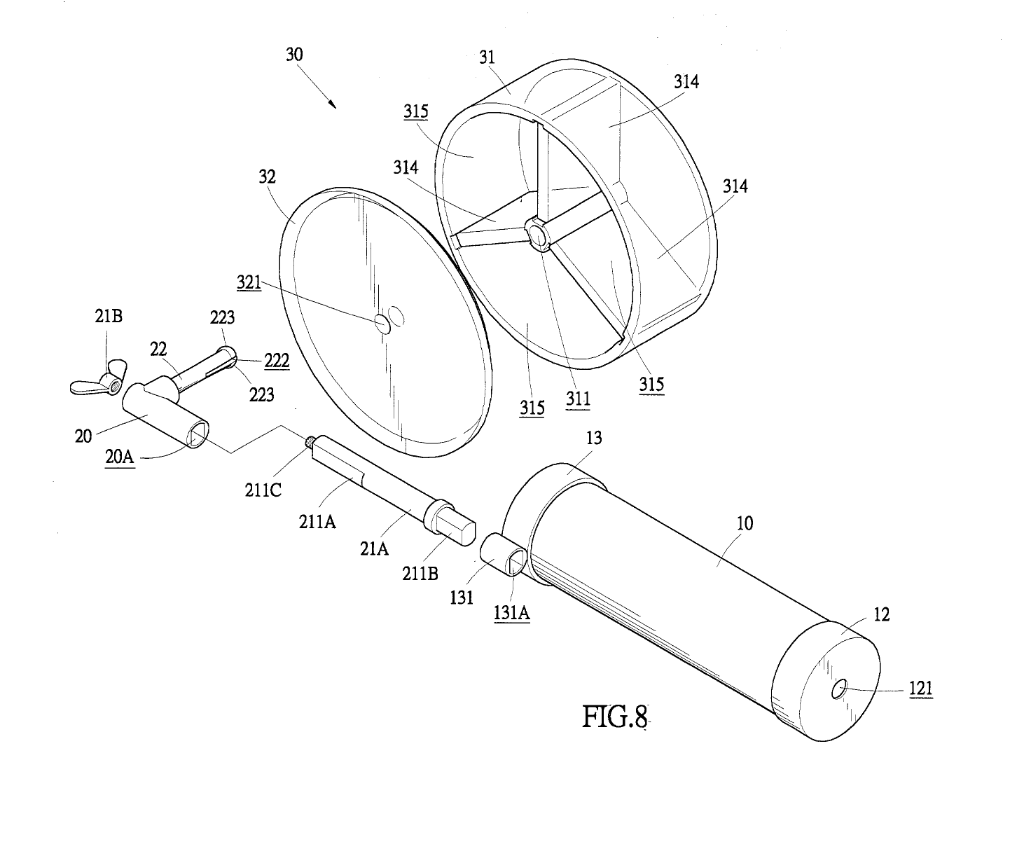

FIG. 8 shows a fifth embodiment of the kaleidoscope in accordance with the present invention. In the fifth embodiment, the support rod 20 is comprised of separate first and second sections 21A, 22. The second section 22 has a remote end in which a slit 222 is defined, preferably cutting through the remote end of the second section 22 in a diametrical direction, dividing the remote end of the second section 22 into two opposing portions that are deformable toward each other for reducing overall cross-sectional size thereof. A ring-like expanded portion 223 is formed on and around the remote end of the second section 22 whereby by deforming the two portions of the remote end of the second section 22, the expanded portion 223 is allowed to pass through the bore of the central hub 311 of the container 30 for attaching the container 30 to the second section 22 of the support rod 20. The second section 22 has an opposite end forming a tubular portion defining a polygonal bore 20A. The first section 21A has a first end 211B having a polygonal cross section for being fit into a tubular retainer 131 that is formed on an outside surface of the lens device 13 and defining a bore 131A complementary in shape to the first end 211B of the first section 21A for tightly receiving the first end 211B of the first section 21A therein and thus attaching the support rod 20 to the tubular body 10. The first section 21A has an opposite second end 211A having a cross section complementary to the bore 20A of the second section 22 for being received in the bore 20A. A threaded extension 211C of the second end 211A of the first section 21A extends beyond the tubular portion of the second section 22 and engageable by a nut 21B for securing the second section 22 to the first section 21A.

Besides the above described modifications, the remaining parts of the kaleidoscope 100 of the fifth embodiment are identical to their counterpart of the first embodiment and thus no further description is needed herein.

As briefly mentioned above and apparent to those having ordinary skills, the shape of the container 30 is in general subject to no constrain. For example, the container 30 can be cylindrical (FIGS. 1, 2, 4 and 5) or having a hexagonal or octagonal cross section (FIG. 6). The compartments 315 inside the container 30 can be sized arbitrarily to provide versatility. Further, the container 30 and the support rod 20 (20′) can be rotated or moved in a number of combination of ways to further enhance the versatility of the kaleidoscope of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A kaleidoscope comprising:
a first sub-assembly comprising:
a tubular body containing a prism therein, the tubular body having a first end forming an observing window and an opposite second end to which a lens device is attached; and
a second sub-assembly attached to the first sub-assembly and comprising:
a support rod having a first section attached the first sub-assembly and a second section, and
a container comprising a transparent casing forming an interior space, the casing forming a hub defining a bore fit over the second section of the support rod whereby the container is rotatable about the second section, partition plates being arranged inside the container to divide the interior space into separate compartments for respectively receiving and containing different contents therein, wherein the rotation of the container moves the compartments and the contents thereof, in sequence, to a position in front of the lens whereby image of the contents is directed by the lens into the prism, forming versatile patterns therein.

2. The kaleidoscope as claimed in claim 1, wherein a tubular retainer is attached to a side surface of the lens device, the first section of the support rod extending through the tubular retainer, threading being formed on the first section of the support rod for engaging two nuts located on opposite sides of the tubular retainer to fix the support rod in position.

3. The kaleidoscope as claimed in claim 2, wherein the first section of the support rod is prevented from axial movement by the nuts on opposite sides of the tubular retainer, while allowed to rotate in the tubular retainer.

4. The kaleidoscope as claimed in claim 1, wherein the second section is externally threaded for engaging two nuts on opposite sides of the container to selectively position the container with respect to the lens device.

5. The kaleidoscope as claimed in claim 1, wherein at least one slit is defined in a remote end of the second section of the support rod, dividing the remote end of the second section into opposing portions which are deformable toward each other, an expanded ring being formed around the remote end of the second section of the support rod for attaching the container to the support rod.

6. The kaleidoscope as claimed in claim 1, wherein the lens device is rotatable with respect to the tubular body.

7. The kaleidoscope as claimed in claim 1, wherein an inner-threaded hole is defined in a remote end of the second section for engaging with a locking nut to secure the container to the support rod.

8. The kaleidoscope as claimed in claim 7, wherein the locking nut comprises a tab movable to a position engaging the container for securely fixing the container to the support rod.

9. The kaleidoscope as claimed in claim 1, wherein an included angle is formed between the first and second sections of the support rod.

10. The kaleidoscope as claimed in claim 9, wherein the first and second sections are substantially perpendicular to each other.

11. The kaleidoscope as claimed in claim 1, wherein the first and second sections of the support rod are axially in line with each other forming a straight rod.

12. The kaleidoscope as claimed in claim 1, wherein the casing of the container forms an opening to which a cover is mounted for defining the interior space.

13. The kaleidoscope as claimed in claim 1, wherein the casing comprises a bottom and a top connected by a surrounding side wall, the hub being formed inside the casing and extending between the top and bottom, pairs of aligned slits being defined in the hub and the side wall for receiving edges of the partition plates and thus retaining the partition plates inside the casing.

14. The kaleidoscope as claimed in claim 1, wherein the container is cylindrical.

15. The kaleidoscope as claimed in claim 1, wherein the casing of the container has a polygonal cross section.

16. The kaleidoscope as claimed in claim 1, wherein the first section is tightly fit into a bore defined in the tubular retainer.

17. The kaleidoscope as claimed in claim 16, wherein the first section has a polygonal cross section tightly fit into the bore of the tubular retainer that is complementary in shape to the polygonal cross section of the first section.

18. The kaleidoscope as claimed in claim 1, wherein the second section of the support rod defines a bore and the first section of the support rod has an end received in the bore, the bore of the second section and the end of the first section having complementary polygonal cross section.

19. The kaleidoscope as claimed in claim 18, wherein the first section has a threaded extension formed on the end thereof and projecting beyond the bore of the second section for engaging a nut to secure the second section to the first section.
